(19) United States
(12) Patent Application Publication
(10) Pub. No.: US 2014/0245660 A1
(43) Pub. Date: Sep. 4, 2014

(54) WEED GUARD

(71) Applicant: Todd D. Rooney, Norwalk, IA (US)

(72) Inventor: Todd D. Rooney, Norwalk, IA (US)

(21) Appl. No.: 13/782,553

(22) Filed: Mar. 1, 2013

(51) Int. Cl. A01G 13/00

(52) U.S. Cl. CPC A01G 13/0293; A01G 13/0256
USPC 47/9

(57) ABSTRACT

A weed guard which forms a barrier along the width and length of a fence line. The weed guard has a protective strip which is preferably flat. Each lateral edge of the protective strip has a plurality of anchoring segments, which resemble teeth, which extend downward and perpendicular to the protective strip. The protective strip has a plurality of perforations therein which form cut-outs which receive fence posts. In operation cut-outs are removed along the perforations and a fence post is received in the cutout. Next the anchoring segments are inserted into the ground. In this position, the protective strip prevents weeds from growing along the bottom edge of the fence line. In this way the aesthetic appearance of a fence line is improved.

### BACKGROUND OF THE INVENTION

This invention is directed toward a weed guard. More specifically, and without limitation, this invention relates to a guard comprised of a protective strip of metal which matingly aligns with fenceposts and is anchored into the ground along a fence line to form a barrier in between the bottom of a section of fence and the ground to prevent the growth of weeds.

Fences are a common fixture in the yards and lawns of home owners, businesses, and the like, as fences not only provide privacy and protection, but also often serve as a decorative addition to a home or business. However, fences present particular difficulties in terms of lawn care and maintenance. Specifically, due to the structure of the fence as well as the associated fenceposts, gates, and the like which interfere with typical lawn mowers, fences present a challenge in managing the growth of weeds and grass around and under the fence's structure. This requires additional time and the inconvenience of trimming or weed eating to maintain the yard's appearance and prevent overgrowth of weeds and grass. Furthermore, the application of chemicals and weed killers to manage such growth along a fence is often undesirable, due not only to their high cost, but also to the additional effort and potentially harmful effects such chemicals have on their surroundings. Therefore there exists a need in the art that addresses these problems.

Therefore a primary object of this invention is to provide a weed guard that forms a barrier along the width and length of a fence line to prevent the overgrowth of grass and weeds.

It is yet another object of this invention to provide a weed guard that is adaptable and can accommodate a variety of different fences having fenceposts or poles of different widths and shapes.

It is a further object of this invention to provide a weed guard that is made of bendable material, is inexpensive, rust-proof, and easy to install.

These and other objects, features or advantages of the present invention will become apparent from the specification, drawings and claims.

### BRIEF DESCRIPTION OF THE DRAWINGS

FIG. 1 is a perspective view of the weed guard of the present invention mounted to a section of fence;

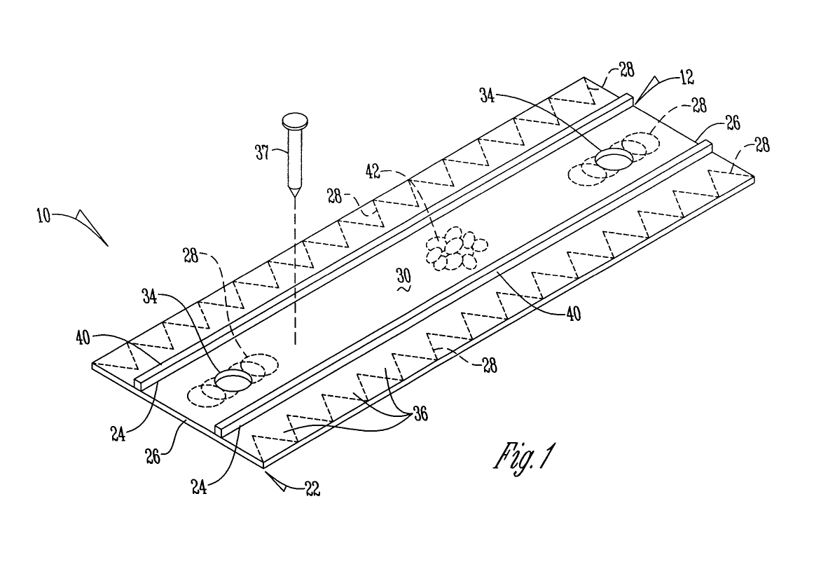

FIG. 2 is a perspective view of the weed guard of the present invention; and

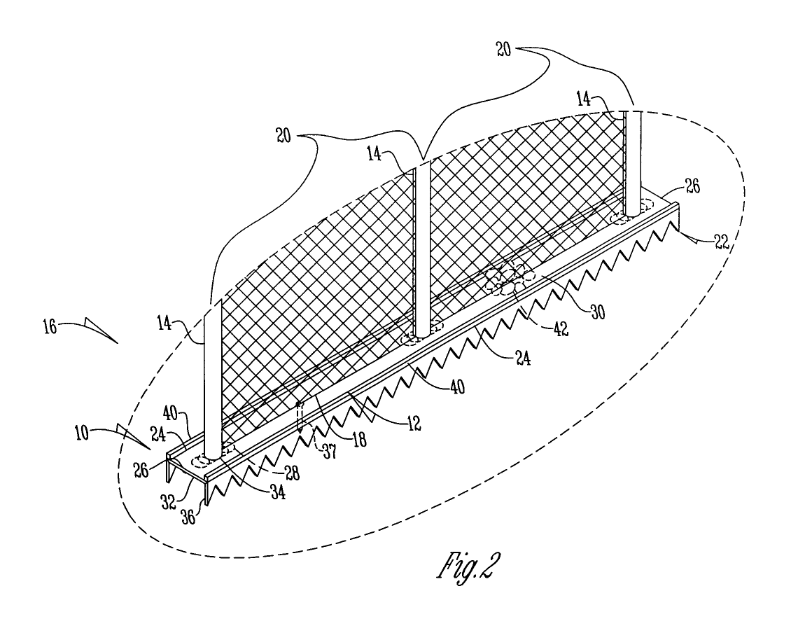

FIG. 3 is a perspective view of the weed guard.

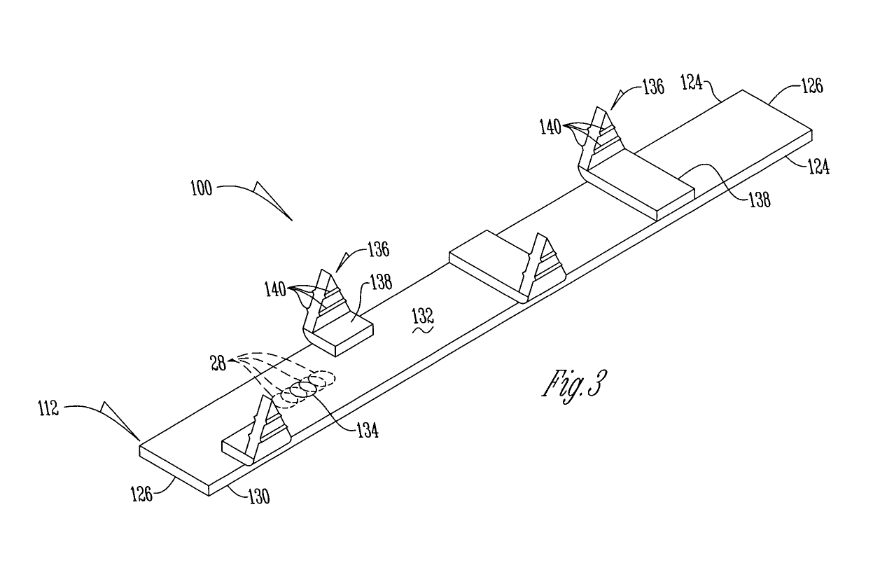

### DETAILED DESCRIPTION OF THE PREFERRED EMBODIMENT

Referring to the figures, a weed guard 10 is disclosed and is comprised of a protective strip 12 which matingly aligns with fence posts 14 and is anchored into the ground along a fence line 16 to form a barrier in between the bottom 18 of a section of fence 20 and the ground to prevent the growth of weeds. In a preferred embodiment, the weed guard 10 is made of a rust-proof, bendable metal. Alternatively, the weed guard can be made from any suitable material capable of forming a barrier in between the bottom 18 of a section of fence 20 and the ground to prevent the growth of weeds.

The weed guard 10 is comprised of one or more segments 22 that are placed under a section of fencing 20 and match or matingly align with the fence posts 14 or poles supporting the sections of fencing 20. Fence posts 14 include but are not limited to metal poles supporting chain link or wrought iron fences, wood or composite plastic fenceposts supporting sections of wood or composite plastic fences, and the like. Each segment 22 of the weed guard includes a protective strip 12. Preferably protective strip 12 is a flat, planar guard surface having opposing lateral edges 24 that extend in parallel spaced alignment to one another. Preferably, the protective strip 12 spans the width of each section of fence 20 and is positioned such that it extends parallel to the section of fence 20. Protective strip 12 terminates in opposing ends 26, which define the length of each segment 22. Preferably the protective strip 12 has a length no shorter than the distance between the poles or fence posts 14 supporting a section of fence 20. The width of the protective strip 12 between lateral edges 24 in a preferred embodiment is wider than the width or diameter of an individual fence post 14 or pole such that the protective strip 12 forms a barrier in between the ground and the section of fence 20 adjacent thereto. In a preferred embodiment, the lateral edges 24 also extend slightly beyond both sides of the width of the section of fence 20.

The protective strip's 12 body includes a plurality of sets of perforations 28 extending therethrough, from the top surface 30 to the bottom surface 32, to form cut-out sections 34 from the interior or body of protective strip 12 between the lateral edges 24. The sets of perforations 28 are placed at multiple intervals between the opposing ends 26 of the protective strip and correspond to sections of fence 20 such that fence posts 14 separated by varying distances are received by corresponding cut-out sections 34 in the protective strip 12. In one embodiment, the cut-out sections 34 are circular to facilitate circular fence posts or poles. Alternatively, the cut-out sections 34 are square to receive square fence posts 14 or poles. Alternatively, any other shape is used for cut-out sections 34 to correspond to any sized and shaped fence post 14.

A plurality of anchoring segments 36 are affixed to the lateral edges 24 of the protective strip 12 and extend perpendicularly downward from the top surface 30 of protective strip 12 along the length of each of the segments 22 of protective strips 12 such that the anchoring segments 36 extend into the ground and mount the protective strip 12 flush with the ground's surface under the each section of fence 20. In a preferred embodiment, the anchoring segments 36 have a triangular shape when viewed from the side. Alternatively, the anchoring segments are any other shape which is capable of securely and easily penetrating the surface of the ground to mount the protective strip 12 thereto such as spikes, screws, or the like. In an alternative arrangement, spikes, screws or the like are passed through the top surface 30 of protective strip 12 to anchor it to the ground. In one arrangement, anchoring segments are formed along perforations 28 which extend along the length of protective strip 12.

In operation, each of the plurality of segments 22 of protective strip 12 and anchoring segments 36 are provided as a single sheet of pliable or bendable material, such as metal, such that the weed guard 10 is manufactured by punching it out of a single piece of material. In one arrangement, the protective strip 12, perforations 28 and anchoring segments 36 are cut out of the single piece of material at one time. Next, the anchoring segments 36 are bent along lateral edges 24 at the factory and the weed guard is ready for use. In this arrangement, lateral edges 24 serve as a fold line. For this arrangement, specifically sized weed guards are needed for each respective size of fence post 14.

Alternatively, the weed guard 10 is not bent along lateral edges 24 at the factory. To install the weed guard 10, the perforations 28 for cut-outs 34 are aligned with the fence posts 14 of a section of fence 20 and the perforations 28 matching the width between respective fence posts 14 are removed to form cut-out sections 34 from the interior or body of the protective strip 12 which align with and match the distance between fence posts 14. In this arrangement, the anchoring segments 36 are then cut from the lateral edges 24 from end 26 to opposing end 26, or alternatively, the anchoring segments 36 are formed by removing material along a perforations 28 which form anchoring segments 36. Once formed, the anchoring segments 36 are bent downward at the appropriate width to match the width of section of fence 20. Each protective strip 12 is placed in between the fence posts 14 with adjacent fence posts 14 matingly aligned with and received by the cut-out sections 34 of the protective strip's 12 body. Finally, the anchoring segments 36 are secured into the ground to securely mount and maintain the position of the protective strip 12 along a fence line 16 to form a barrier in between the bottom 18 of a section of fence 20 and the ground to prevent the growth of weeds.

In another arrangement, an upwardly extending lip extends a distance above top surface 30 and extends along the length of each lateral edge 24, or any position therebetween, thereby forming an upwardly shaped channel. In this arrangement, upwardly shaped cannel is useful for holding decorative stone or rock along the bottom edge of fence 20, thereby providing an improved aesthetic appearance. In this arrangement, drain holes are hereby contemplated in surface 30 so as to drain rain water out of upwardly shaped channel.

Therefore, a weed guard has been provided that forms a barrier along the width and length of a fence line to prevent the overgrowth of grass and weeds, accommodates a variety of different fences having fenceposts or poles of different widths and shapes, is made of bendable, rustproof metal, and furthermore is inexpensive, and easy to install.

It will be appreciated by those skilled in the art that other various modifications could be made to the device without parting from the spirit and scope of this invention. All such modifications and changes fall within the scope of the claims and are intended to be covered thereby.

1. A weed guard system which prevents the growth of weeds along a fence line, comprising:
a protective strip extending a width between lateral edges and extending a length between opposing ends;
a plurality of anchoring segments connect along the lateral edges of the protective strip and extend downward from the protective strip;
a plurality of sets of perforations positioned in the protective strip which form cut-outs when removed;
a pair of lips connect along the lateral edges of the protective strip and extend upwardly from the protective strip thereby defining a upwardly shaped channel there between;
wherein the anchoring segments are formed of a series of downward pointing triangles when viewed from the side;
wherein when the anchoring segments are inserted into the ground the protective strip prevents the growth of weeds; and
wherein stones or rocks are positioned in the upwardly shaped channel.

2. The weed guard of claim 1 wherein the protective strip is formed of a metallic material.

3. The weed guard of claim 1 wherein the protective strip is formed of a bendable material.

4. The weed guard of claim 1 wherein the plurality of sets of perforations are sized and shaped to receive fence posts.

5. (canceled)

6. A weed guard system which prevents the growth of weeds along a fence line, comprising:
a protective strip extending a width between lateral edges and extending a length between opposing ends;
a plurality of anchoring segments connect along the lateral edges of the protective strip and extend downward from the protective strip;
a plurality of sets of perforations positioned in the protective strip which form cut-outs when removed;
a pair of lips connect along the lateral edges of the protective strip and extend upwardly from the protective strip thereby defining a upwardly shaped channel there between;
wherein the anchoring segments are formed of a series of downward pointing triangles when viewed from the side;
wherein when the anchoring segments are inserted into the ground the protective strip prevents the growth of weeds;
wherein stones or rocks are positioned in the upwardly shaped channel; and
wherein the plurality of sets of perforations are placed at multiple intervals between the opposing ends of the protective strip and correspond to sections of fence such that fence posts separated by varying distances are received by corresponding cut-outs in the protective strip.

7. The weed guard of claim 1 wherein the perforations extend through the protective strip.

8. (canceled)

9. (canceled)

10. A method of using a weed guard system which prevents the growth of weeds along a fence line, comprising the steps of:
providing a protective strip extending a width between lateral edges and extending a length between opposing ends;
forming a plurality of anchoring segments extending along the lateral edges of the protective strip wherein the anchoring segments are formed of a series of triangles when viewed from the side;
forming a pair of lips that connect along the lateral edges of the protective strip and extend upwardly from the protective strip thereby defining a upwardly shaped channel there between;
bending the plurality of anchoring segments downward from the protective strip;
forming a plurality of sets of perforations in the protective strip;
removing at least one cut-out from the protective strip;
inserting the anchoring segments into the ground adjacent the bottom edge of a fence;
inserting a fence post in each cut-out;
placing rocks or stones in the channel formed by the pair of lips.

11. (canceled)

12. The method of claim 10 wherein the plurality of sets of perforations are placed at multiple intervals between the opposing ends of the protective strip and correspond to sections of fence such that fence posts separated by varying distances are received by corresponding cut-out in the protective strip.
